(19) United States
(12) Patent Application Publication
(10) Pub. No.: US 2014/0213248 A1
(43) Pub. Date: Jul. 31, 2014

(54) MOBILE DEVICE AND METHOD OF SCANNING FOR CHANNELS

(71) Applicant: HON HAI PRECISION INDUSTRY CO., LTD., New Taipei (TW)

(72) Inventor: HAN-TZUNG LIN, New Taipei (TW)

(73) Assignee: HON HAI PRECISION INDUSTRY CO., LTD., New Taipei (TW)

(21) Appl. No.: 14/059,514

(22) Filed: Oct. 22, 2013

(30) Foreign Application Priority Data
Jan. 31, 2013 (CN) 2013100387560

(51) Int. Cl. H04W 48/16

(52) U.S. Cl. CPC H04W 48/16
USPC 455/434

(57) ABSTRACT

A mobile device used for channel scanning includes a channel management module, a positioning module, a matching module, and a scanning module. The channel management module is used to establish a channel list. The channel list includes position data and corresponding channel information. The positioning module acquires real-time position data of the mobile device through a positioning system of the mobile device. The matching module is used to acquire the channel information from the channel list which corresponds to the real-time position data of the mobile device. The scanning module scans and connects to one channel according to the acquired channel information. A channel scanning method is also provided.

### BACKGROUND

1. Technical Field

Embodiments of the present disclosure generally relate to scanning of channels in wireless communication, and more particularly to a mobile electronic device and a channel scanning method of the mobile device.

2. Description of Related Art

Nowadays, with the development of Worldwide Interoperability for Microwave Access (WiMAX®) technology, more and more mobile devices access a wireless network via this technology. Generally, when a mobile device accesses the wireless network, the mobile device needs to scan a proper channel; i.e. a suitable, ideal or desired channel. Currently, there are two approaches to scanning the proper channel. First, there is the use of the traditional method to scan the proper channel, which is to scan all channels in a band until connecting to the proper channel. However, this method takes much time. Second, the proper channel can be scanned directly, but only if the channel parameter is obtained first. In a word, the two current methods to scan the proper channel are limited in use and/or effectiveness.

Further, wireless communication networks are developing quickly, and the above-described two methods of scanning for channels may not be able to meet people's heightened needs for information speedily obtainable. Thus a method to scan channels quickly and efficiently is needed, and a mobile device implementing such method is also needed.

### BRIEF DESCRIPTION OF THE DRAWINGS

FIG. 1 is a schematic diagram of an application environment and functional modules of a mobile device in accordance with one embodiment of the present disclosure.

FIG. 2 is an exemplary embodiment of a channel list of the mobile device of FIG. 1.

FIG. 3 is a schematic diagram of an application environment and functional modules of a mobile device in accordance with another embodiment of the present disclosure.

FIG. 4 is a flowchart of an exemplary embodiment of a channel scanning method in accordance with the present disclosure, the method employed by the mobile device of FIG. 1.

FIG. 5 is a flowchart of details of one step of FIG. 4, namely, acquiring position data corresponding to real-time position data of the mobile device in the channel list and obtaining channel information corresponding to the acquired position data.

### DETAILED DESCRIPTION

The embodiments are illustrated by way of example and not by way of limitation in the figures of the accompanying drawings in which like references numerals indicate similar elements. It should be noted that references to “an” or “one” embodiment in this disclosure are not necessarily to the same embodiment, and such references can mean “at least one.”

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

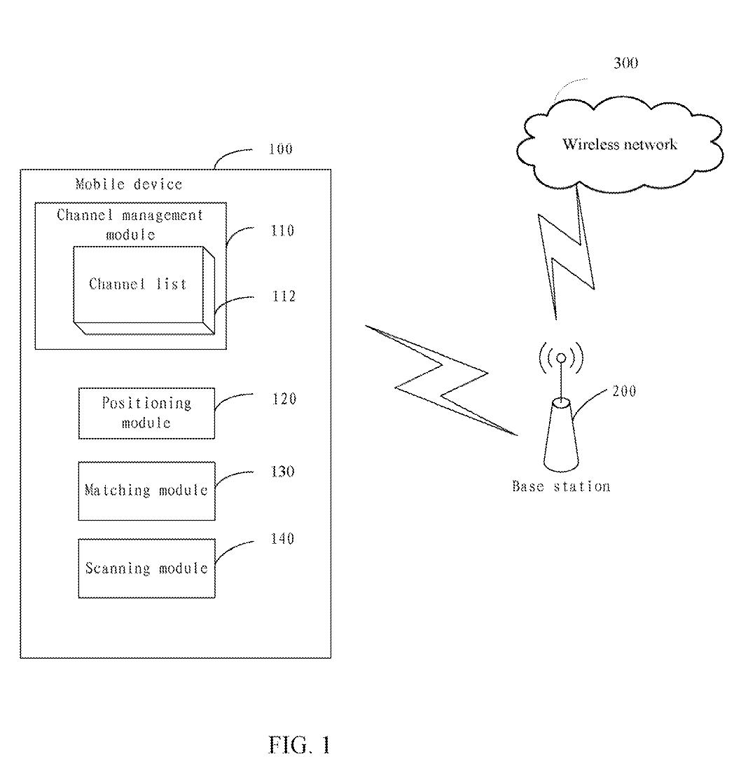

FIG. 1 is a schematic diagram of an application environment and functional modules of a mobile device 100 in accordance with one embodiment of the present disclosure. In the present embodiment, the mobile device 100 accesses a wireless network 300 via a proper channel between the mobile device 100 and one of a plurality of base stations 200 (only one shown in FIG. 1). A “proper channel” can be considered to be a suitable, ideal or desired channel. The mobile device 100 can be a smart phone, a tablet, a notebook or other device having a wireless communication function. In the present embodiment, the base stations 200 can offer Worldwide Interoperability for Microwave Access (WIMAX®) service, Wireless Fidelity (WIFI®) service and third-generation (3G) service for the mobile device 100.

In the embodiment, the mobile device 100 comprises a channel management module 110, a positioning module 120, a matching module 130, and a scanning module 140.

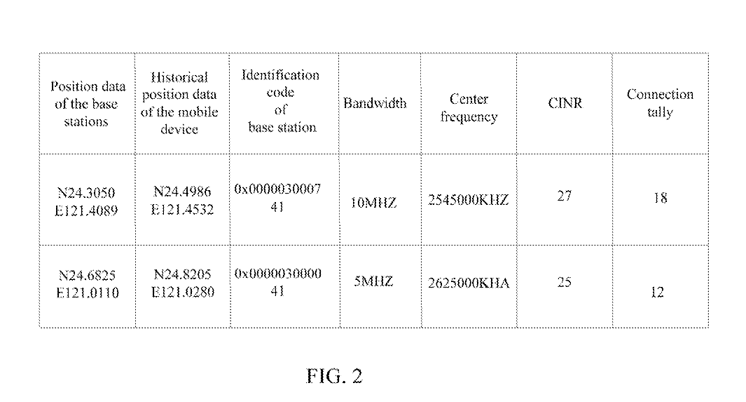

The channel management module 110 stores a channel list 112. FIG. 2 shows an exemplary embodiment of the channel list 112. The channel list 112 comprises position data and corresponding channel information. In the illustrated embodiment, the position data comprises historical position data of the mobile device 100 and position data of the base stations 200. The historical position data of the mobile device 100 shows only the data for the most recent occasion on which the mobile device 100 communicated with each of the base stations 200. The channel information comprises respective identification codes of the base stations 200, bandwidths of the corresponding channels, respective center frequencies of the channels, respective carrier to interference plus noise ratios (CINRs) of the channels, and the number of times the mobile device 100 has connected to each of the channels. In the following description, unless the context indicates otherwise, the number of times the mobile device 100 has connected to a channel is referred to as a “connection tally.”

In the embodiment, the position data in the channel list 112 can be represented by longitude and latitude. For example, the historical position data of the mobile device 100 can be (N24.4986 E121.4532) for the most recent occasion on which the mobile device 100 communicated with a first one of the base stations 200 (see FIG. 2), and the position data of the first base station 200 can be (N24.3050 E121.4089). The identification codes of the base stations 200 can represent the channels respectively corresponding to the base stations 200. The identification codes may be encoded by six components: the first three of which represent operators of the base stations 200, and remainder of which represent the one channel set by each of the base stations 200. In the embodiment, the bandwidth of each channel and the center frequency of the channel are the basic parameters of the channel, and the scanning module 140 can scan each channel according to the bandwidth of the channel and the center frequency of the channel. In the embodiment, each channel has a CINR, and the CINR represents the quality of the channel. Thus, a proper channel can be chosen from channels which have been scanned by the scanning module 140 based on the CINRs of the channels. The connection tally for each channel can represent whether the channel is often connected to.

The positioning module 120 acquires real-time position data of the mobile device 100. In the embodiment, the positioning module 120 is a module of a Global Positioning System (GPS).

The matching module 130 acquires certain of the position data corresponding to the real-time position data of the mobile device 100 in the channel list 112, and obtains the channel information corresponding to the acquired position data.

In the illustrated embodiment, the matching module 130 also calculates distances between the real-time position of the mobile device 100 and the positions of the base stations 200 when the channel list 112 has the position data of the base stations 100. The matching module 130 further determines whether the distances between the real-time position of the mobile device 100 and the positions of the base stations 200 are all under coverage of signals of the wireless network 300. In the embodiment, the coverage of the signals of the wireless network 300 may be 30 kilometers, and the scanning module 140 ignores the channel information corresponding to the positions of the base stations 200 when any one of the distances between the real-time position of the mobile device 100 and the base stations 200 is longer than 30 kilometers. Otherwise, the scanning module 140 acquires the channel information corresponding to the positions of the base stations 200.

The matching module 130 calculates distances between the real-time position of the mobile device 100 and historical positions of the mobile device 100 when the channel list 112 does not have the positions of the base stations 200. The matching module 130 then compares the distances between the real-time position of the mobile device 100 and the historical positions of the mobile device 100 with a default distance value. In the embodiment, the default may be set as 5 kilometers. When any one or more of the distances between the real-time position of the mobile device 100 and the historical positions of the mobile device 100 is higher than 5 kilometers, (which represents the mobile device 100 being far away from the historical positions), the matching module 130 ignores the channel information corresponding to the historical positions. When the distances between the real-time position of the mobile device 100 and the historical positions of the mobile device 100 are all lower than 5 kilometers, (which represents the mobile device 100 being near the historical positions), the matching module 130 acquires the channel information corresponding to the historical positions. In other embodiments, the default may be set as any other suitable value.

The scanning module 140 sorts the channels corresponding to the channel information from high to low based on the CINRs of the channels. Then the scanning module 140 scans the sorted channels one by one from high to low CINR until it connects to one channel. If the scanning module 140 can not connect to one channel among the sorted channels, the scanning module 140 scans all the channels in the WIMAX® network.

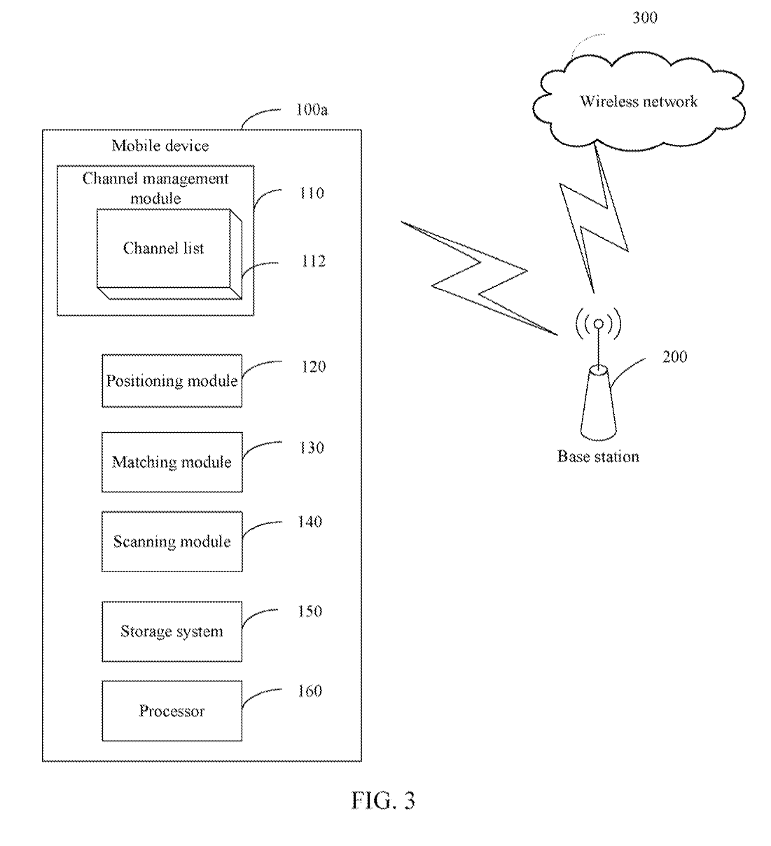

FIG. 3 is a schematic diagram of an application environment and functional modules of a mobile device 100a in accordance with another embodiment of the present disclosure. The mobile device 100a is similar to the mobile device 100. The difference is that the mobile device 100a further comprises a storage system 150 and at least one processor 160. In the illustrated embodiment, there is a single processor 160 only. Programs are stored in the storage system 150, and are executed by the processor 160. The programs relate to the functions of the positioning module 120, the matching module 130, and the scanning module 140.

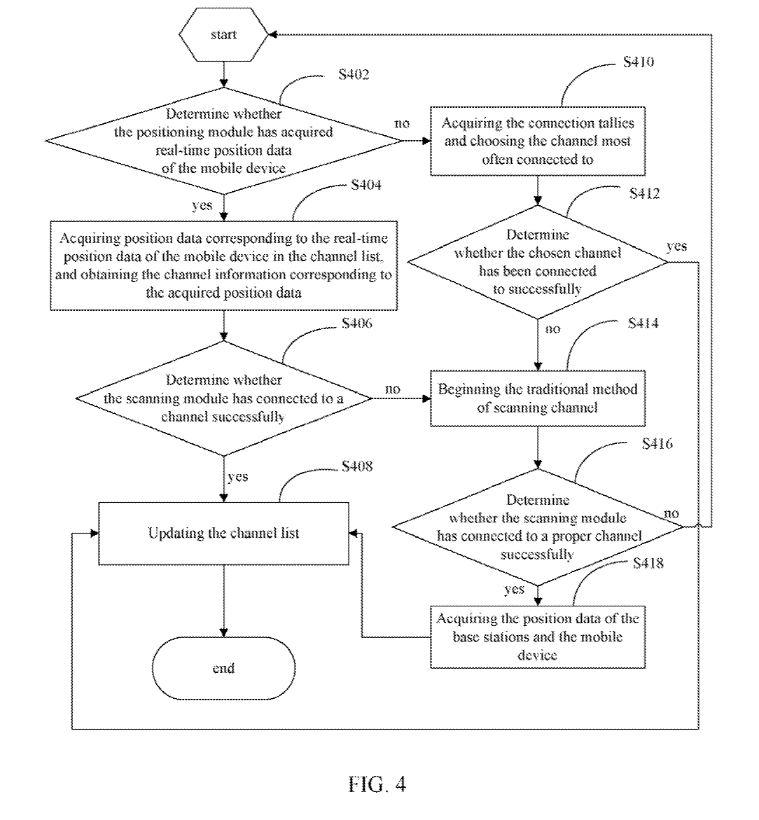

FIG. 4 is a flowchart of an exemplary embodiment of a channel scanning method in accordance with the present disclosure, the method employed by the mobile device 100. In the exemplary embodiment, the method is implemented in the application environment shown in FIG. 1 in the following manner.

In block S402, the positioning module 120 determines whether it has acquired the real-time position data of the mobile device 100. In the embodiment, the real-time position data is represented by longitude and latitude. When the positioning module 120 has not acquired the real-time position data of the mobile device 100, in block S410, the scanning module 140 acquires the connection tally for each of the channels from the channel list 112. The connection tally for each channel represents whether the channel is often connected to. Then the scanning module 140 chooses the channel which is most often connected to in the channel list 112 according to the connection tallies. In block S412, the scanning module 140 determines whether the chosen channel has been connected to successfully.

When in block S402 the positioning module 120 has acquired the real-time position data of the mobile device 100, in block S404, the matching module 130 searches for and acquires certain of the position data corresponding to the real-time position data of the mobile device 100 in the channel list 112, and obtains the channel information corresponding to the acquired position data.

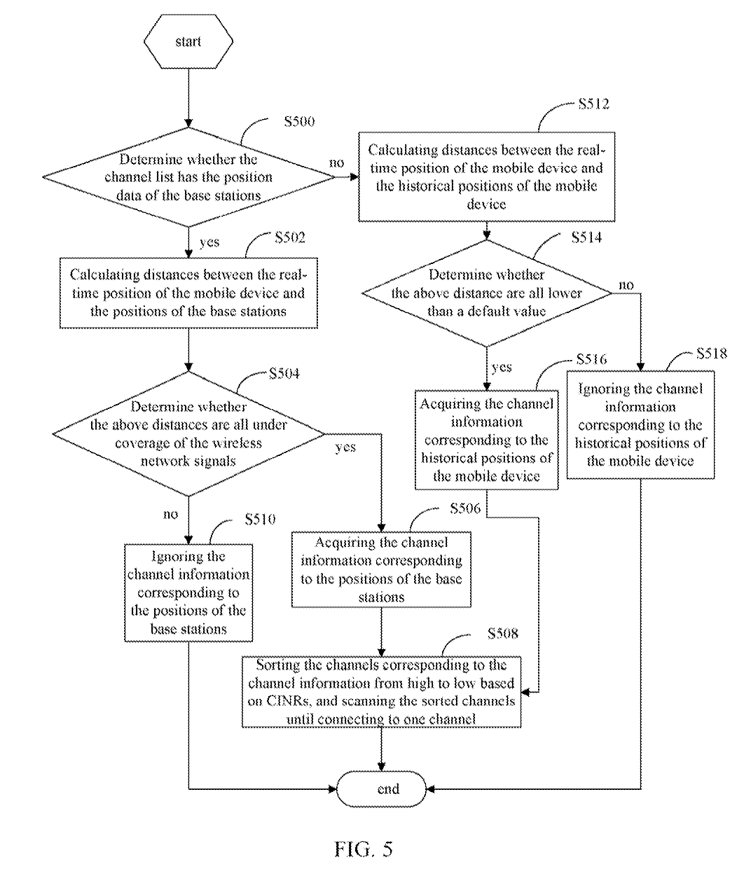

FIG. 5 is a flowchart of details of block S404. In block S500, the matching module 130 determines whether the channel list 112 has the position data of the base stations 200. When the channel list 112 has the position data of the base stations 200, in block S502, the matching module 130 calculates distances between the real-time position of the mobile device 100 and the positions of the base stations 200. In block S504, the matching module 130 determines whether the distances between the real-time position of the mobile device 100 and the base stations 200 are all lower than the coverage of signals of the wireless network 300. For example, the coverage of the signals of the WIMAX® network can be 30 kilometers. When the distances between the real-time position of the mobile device 100 and the base stations 200 are all lower than 30 kilometers, in block S506, the matching module 130 acquires the channel information corresponding to the positions of the base stations 200. In block S508, the scanning module 140 sorts the channels corresponding to the channel information from high to low based on the CINRs of the channels. Then the scanning module 140 scans the sorted channels one by one from high to low CINR until it connects to one channel. When any one of the distances between the real-time position of the mobile device 100 and the base stations 200 is longer than 30 kilometers, in block S510, the matching module 130 ignores the channel information corresponding to the positions of the base stations 200.

When in block S500 the channel list 112 does not have the positions of the base stations 200, in block S512, the matching module 130 calculates distances between the real-time position of the mobile device 100 and the historical positions of the mobile device 100. In block S514, the matching module 130 compares the distances between the real-time position of the mobile device 100 and the historical positions of the mobile device 100 with the default distance value. In the embodiment, the default can be set as 5 kilometers. When the distances between the real-time position of the mobile device 100 and the historical positions of the mobile device 100 are all lower than the default, in block S516, the matching module 130 acquires the channel information corresponding to the historical positions of the mobile device 100. In block S508, the scanning module 140 sorts the channels corresponding to the channel information from high to low based on the CINRs of the channels. Then the scanning module 140 scans the sorted channels one by one from high to low CINR until it connects to one channel. When any one or more of the distances between the real-time position of the mobile device 100 and the historical positions of the mobile device 100 is not lower than the default, in block S518, the matching module 130 ignores the channel information corresponding to the historical positions of the mobile device 100.

Referring back to FIG. 4, in block S406, the scanning module 140 determines whether it has connected to a channel successfully. When the scanning module 140 has not connected to a channel successfully, the procedure goes to block S414 described below. When the scanning module 140 has connected to a channel successfully, the procedure goes to block S408 described below.

When in block S412 the scanning module 140 determines that the chosen channel has not been connected to successfully, the procedure goes to block S414 described below.

In block S414, the scanning module 140 begins to scan all the channels around the mobile device 100 according to the traditional method (see above).

In block S416, the scanning module 140 determines whether it has connected to a proper channel successfully.

When in block S416 a proper channel can not be acquired or connected to successfully, then the procedure of the channel scanning method returns to the start.

When in block S416 the proper channel is connected to, in block S418, the channel management module 110 acquires the position data of the base stations 200 and the mobile device 100 according to the wireless network 300. Then the procedure goes to block S408 described below.

When in block S412 the scanning module 140 determines that the chosen channel has been connected to successfully, the procedure goes to block S408 described below.

In block S408, the channel management module 110 updates the channel list 112. For example, the channel management module 110 updates the historical position data of the mobile device 100 and updates the connection tally for the channel connected to. The channel management module 110 may also update the identification codes of the base stations 200, and the CINRs.

In summary, users can quickly connect to the proper channel in, e.g., the WIMAX® network 300 according to the above-described method of scanning for channels.

While various embodiments and methods have been described above, it should be understood that they have been presented by way of example only and not by way of limitation. Thus the breadth and scope of the present disclosure should not be limited by the above-described embodiments, and should be at least commensurate with the following claims and their equivalents.

What is claimed is:

1. A mobile device comprising:
at least one processor;
a storage system;
one or more programs that are stored in the storage system and are executed by the at least one processor, the one or more programs comprising:
a channel management module, which creates a channel list which comprises position data and corresponding wireless communication channel information, the position data of the channel list comprising position data of the mobile device;
a positioning module, which is configured to acquire real-time position data of the mobile device;
a matching module, which acquires certain of the position data corresponding to the real-time position data of the mobile device in the channel list, and obtains channel information corresponding to the acquired position data; and
a scanning module, which scans channels according to the obtained channel information.

2. The mobile device of claim 1, wherein the position data of the channel list further comprises position data of one or more base stations associated with a wireless network, and the matching module calculates distances between the real-time position of the mobile device and positions of the base stations, determines whether the distances between the real-time position of the mobile device and the positions of the base stations are all under coverage of signals of the wireless network, and acquires the channel information corresponding to the positions of the base stations when the distances between the real-time position of the mobile device and positions of the base stations are all under coverage of signals of the wireless network.

3. The mobile device of claim 1, wherein the position data of the mobile device comprises historical position data of the mobile device, and the matching module calculates distances between the real-time position of the mobile device and historical positions of the mobile device, and acquires the channel information corresponding to the historical positions of the mobile device when the distances between the real-time position of the mobile device and the historical positions of the mobile device are all lower than a default value.

4. The mobile device of claim 1, wherein the channel list further comprises connection tallies each defined as the number of times the mobile device has connected to a channel of a respective one of base stations associated with a wireless network, the channel list still further comprises identification codes of the base stations, the scanning module chooses a channel most often connected to from the channel list according to the connection tallies when the real-time position data of the mobile device can not be acquired, and the channel management module updates the historical position data of the mobile device and the connection tally of the chosen channel in the channel list upon condition that the chosen channel is connected to successfully.

5. The mobile device of claim 4, wherein the scanning module is operable to scan all channels around the mobile device upon condition that the chosen channel is not connected to successfully; the channel management module acquires the position data of the mobile device and position data of one or more base stations associated with a wireless network when a proper channel among all the channels is connected to successfully; and the channel management module updates the channel list based on the position data thus acquired by the channel management module.

6. The mobile device of claim 2, wherein the scanning module is operable to scan all channels around the mobile device upon condition that no channel of the acquired channel information is connected to successfully; the channel management module acquires the position data of the mobile device and the position data of one or more base stations associated with the wireless network when a proper channel among all the channels is connected to successfully; and the channel management module updates the channel list based on the position data thus acquired by the channel management module.

7. A wireless communication channel scanning method, applied to a mobile device, the method comprising:
creating a channel list which comprises position data and corresponding wireless communication channel information, the position data of the channel list comprising position data of the mobile device;
determining whether real-time position data of the mobile device has been acquired;
acquiring certain of the position data corresponding to the real-time position data of the mobile device in the channel list upon condition that the real-time position data of the mobile device has been acquired, and obtaining channel information corresponding to the acquired position data; and
scanning one or more channels according to the obtained channel information.

8. The method of claim 7, wherein the position data of the channel list further comprises position data of one or more base stations associated with a wireless network, and acquiring certain of the position data corresponding to the real-time position data of the mobile device in the channel list and obtaining channel information corresponding to the acquired position data comprises:
calculating distances between the real-time position of the mobile device and positions of the base stations, and determining whether the distances between the real-time position of the mobile device and the positions of the base stations are all under coverage of the wireless network signal; and
acquiring the channel information corresponding to the positions of the base stations when the distances between the real-time position of the mobile device and the positions of the base stations are all under coverage of signals of the wireless network.

9. The method of claim 7, wherein the position data of the mobile device comprises historical position data of the mobile device, and acquiring certain of the position data corresponding to the real-time position data of the mobile device in the channel list and obtaining channel information corresponding to the acquired position data comprises:
calculating distances between the real-time position of the mobile device and historical positions of the mobile device; and
acquiring the channel information corresponding to the historical positions of the mobile device when the distances between the real-time position of the mobile device and the historical positions of the mobile device are all lower than a default value.

10. The method of claim 7, further comprising:
updating the channel list when a channel is connected to successfully.

11. The method of claim 7, wherein the channel list further comprises connection tallies each defined as the number of times the mobile device has connected to a channel of a respective one of base stations associated with a wireless network, the connection tallies represent whether each of the channels is often connected to, the channel list still further comprises identification codes of the base stations, and the method further comprises:
choosing a channel most often connected to according to the connection tallies when the real-time position data of the mobile device has not been acquired; and
updating the historical position data of the mobile device and the connection tally of the chosen channel in the channel list upon condition that the chosen channel is connected to successfully.

12. The method of claim 11, further comprising:
scanning all channels around the mobile device upon condition that the chosen channel is not connected to successfully;
acquiring the position data of the mobile device and position data of one or more base stations associated with a wireless network when a proper channel among all the channels is connected to successfully; and
updating the channel list based on the position data thus acquired.

13. The method of claim 8, further comprising:
scanning all channels around the mobile device upon condition that no channel of the acquired channel information is connected to successfully;
acquiring the position data of the mobile device and the position data of one or more base stations associated with the wireless network when a proper channel among all the channels is connected to successfully; and
updating the channel list based on the position data thus acquired.
